(19) United States
(12) Patent Application Publication
(10) Pub. No.: US 2022/0144108 A1
(43) Pub. Date: May 12, 2022

(54) ELECTRICAL VEHICLE CHARGING SYSTEM FOR CHARGING AN ELECTRICAL VEHICLE

(71) Applicant: ABB Schweiz AG, Baden (CH)

(72) Inventors: Francisco Garcia-Ferre, Baden (CH); Moritz Boehm, Mellingen (CH); Jaroslav Hemrle, Baden-Dättwil (CH); Matteo Bortolato, Trebaseleghe (PD) (IT); Emmanuel Logakis, Baden-Dättwil (CH); Jean-Marc Oppliger, Fislisbach (CH)

(73) Assignee: ABB Schweiz AG, Baden (CH)

(21) Appl. No.: 17/582,757

(22) Filed: Jan. 24, 2022

Related U.S. Application Data
(63) Continuation of application No. PCT/EP2020/071027, filed on Jul. 24, 2020.

(30) Foreign Application Priority Data
Jul. 25, 2019 (EP) 19188382.6

(51) Int. Cl. B60L 53/16; B60L 53/302; B60L 53/18; H01R 13/502; H01R 13/05

(52) U.S. Cl. CPC B60L 53/16; B60L 53/302; H01R 2201/26; H01R 13/502; H01R 13/05; B60L 53/18

(57) ABSTRACT

An electrical plug connector for charging electric vehicles includes a connector housing, a mating interface structure supported and positioned within the connector housing, a positive contact pin for connection with a positive conductor of a charging cable and a negative contact pin for connection with a negative conductor of the charging cable, and a contact pin insert supporting the positive contact pin and/or the negative contact pin, wherein the positive contact pin and/or the negative contact pin are/is received and secured in position by the contact pin insert, and wherein the contact pin insert is insertable and received within the mating interface structure.

### CROSS-REFERENCE TO RELATED APPLICATIONS

This patent application claims priority to European patent application 19188382.6, filed on Jul. 25, 2019, and to International patent application no. PCT/EP2020/071027, filed on Jul. 24, 2020, which are incorporated by reference herein.

### FIELD OF THE DISCLOSURE

The present disclosure relates to a system and method for an electrical plug connector for charging of electric vehicles, comprising a connector housing, a mating interface structure supported and positioned within the connector housing, a positive contact pin for connection with a positive conductor of a charging cable and a negative contact pin for connection with a negative conductor of the charging cable. The invention further relates to a method for assembling such a connector.

### BACKGROUND OF THE INVENTION

In response to global warming and pollution challenges, the automotive industry is accelerating the development and commercialization of electric vehicles. This trend has a high visibility and acceptance among end-customers. The business of electric vehicle charging infrastructure (EVCI) is therefore growing rapidly as well and there is currently a compelling need to support the automotive industry while ensuring safety, but also efficiency and performance.

At present, the EVCI products rely on connectors provided by a number of suppliers. Depending on the ratings (which in turn determine the charging speed for a given battery), the connectors may require either non-cooled or cooled cable systems. The connectors available in the market are based on well-known technologies (i.e. electrical contact solutions, cabling, etc.), but the application is rather new. As a matter of fact, the EVCI connector technology is at an early stage, and the connectors offered by suppliers are still first or second generation designs. The field-experience with this kind of devices is limited. Reasonable feedback on design, functionality, implementation, and operating performance is becoming available to engineers and designers just now. The available standards for EVCI applications are also at an early stage, and are currently rather weak and/or incomplete. A drawback of prior art liquid cooled charging connectors is an insufficient thermal performance of the cooling system.

Recent field service activities have shed light on a number of issues with the products installed in the field. Those issues have a relevant impact on safety and reliability, and must be addressed properly in order to protect end-users and our business, as well.

One major issues is the poor dielectric design of most known arrangements of the connector interface. The safety of the EVCI connectors largely depends on the dielectric design. Most suppliers currently offer poor dielectric design. For example, some connector have a single insulation concept, in which the creepage distance is small (i.e. 16 mm), and in which there are screws in between the contact pins/DC poles of the connector. Moreover, the mating interface is not exchange-able. Such a design may lead to undesired flashovers through the screws in between the DC poles, with unacceptably high risks for end-users. This kind of is-sue was observed in a case in Norway in early 2019.

Other known connectors have a better (yet still not totally acceptable) dielectric design, for example comprising a double insulation and a set of contacts inside the connector body that is not exchangeable. Such connector also may have an exchangeable interface containing another set of contacts. The latter are replaced together with the interface upon damage of the part. The resulting creepage distance is 47 mm in the exchangeable interface and 61 mm in the non-exchangeable interface. Such a connector is better compared to the previously described connector in terms of dielectric strength and exchangeability of the mating interface. On the other hand, it contains a double set of contacts, and the solution is therefore more expensive. Moreover, it still contains screws close to the live parts (specifically, in between the DC poles).

Another major issue of known arrangements is a poor monitoring of the temperature of the contact materials. Ideally, the temperature of the contact materials during charging should be measured directly on the live parts. Because this is difficult to achieve, suppliers rely on alternative solutions which are easier to implement. Some of those solutions are: (i) placing thermocouples on the cables close to the crimping of the contact material with the cable conductor; (ii) applying thermistors on the non-exchangeable live parts inside the connector body; (iii) using a single thermocouple between DC poles. None of these options provides an accurate and reliable measurement of the temperature of the contact materials.

### BRIEF SUMMARY OF THE INVENTION

The present disclosure is directed to a charging connector for charging an electrical vehicle that overcomes the drawbacks explained before, in particular to provide a charging connector which addresses to the dielectric design and the exchangeability of the mating interface and to accuracy of the temperature monitoring system.

### BRIEF DESCRIPTION OF THE SEVERAL VIEWS OF THE DRAWING(S)

These and other aspects of the invention will be apparent from and elucidated with reference to the embodiments described hereinafter.

FIG. 1 shows an exploded view of an embodiment of a connector in accordance with the disclosure.

FIG. 2 shows the embodiment of FIG. 1 in an assembled state.

FIG. 3 shows an embodiment of a strengthened mating interface.

FIG. 4 shows a contact pins for an embodiment of the invention.

FIG. 5 shows the contact pin of FIG. 4 with a blocking element for an embodiment of the invention.

FIG. 6 shows a further embodiment of a part of a connector of the invention in a sectional view and in an assembled state.

FIG. 7 shows a blocking element for a connector of the invention in a perspective view.

FIG. 8 shows an embodiment of a contact pin insert and a mating interface for the invention with a mating structure in a perspective view.

FIG. 9 shows another embodiment of a contact pin insert and a mating interface for the invention with a mating structure in a perspective view.

FIG. 10 shows another embodiment of a contact pin insert for the invention with a mating structure in top view.

### DETAILED DESCRIPTION OF THE INVENTION

While the invention has been illustrated and described in detail in the drawings and foregoing description, such illustration and description are to be considered illustrative or exemplary and not restrictive; the invention is not limited to the dis-closed embodiments. Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

In one aspect, the present disclosure describes an electrical plug connector for charging of electric vehicles, comprising: a connector housing, a mating interface structure supported and positioned within the connector housing, a positive contact pin for connection with a positive conductor of a charging cable and a negative contact pin for connection with a negative conductor of the charging cable, and a contact pin insert supporting the positive contact pin and/or the negative contact pin, wherein the positive contact pin and/or the negative contact pin are/is received and secured in position by the contact pin insert, and wherein the contact pin insert is insertable and received within the mating interface structure.

In another aspect, the present disclosure describes a method for assembling an electrical plug connector, in particular an electrical plug connector as describer before, wherein in a first step a contact pin for connection with a conductor of a charging cable is inserted into a contact pin insert for supporting the contact pin and is secured in position by the contact pin insert, wherein in a following step the contact pin insert with the contact pin supported and secured in position therein is inserted into the mating interface structure, and wherein in further following step the mating interface structure with the contact pin insert and the contact pin is inserted into a connector housing, such that the mating interface structure supported and positioned within the connector housing.

It should be appreciated that one concept of the invention to solve the problem of an insufficient dielectric design of the prior art is to avoid using screws anywhere close to the live parts of the connector, and especially to avoid screws between the DC contacts. Therefore, the invention provides a new concept regarding the connector housing, which may not completely house the other elements of the connector but may be provided in form of a connector body, the mating interface, cable connections and the contact pins. The further provides a new concept regarding a locking of the contact pins and a locking of the mating interface with the connector body, wherein the term locking essentially is to be understood with the meaning of securing in position. The invention provides a smart arrangement of the mating interface/connector interface, enabling a robust dielectric design and in certain embodiments an improved temperature monitoring.

A main advantage of the invention is that the contact pins are secured in position relative to the mating interface without the need to use screws or similar metal fastening means, thereby providing an enhanced dielectric design and in particular a very large creepage distance. Further, the connector according to the invention is very easy to assemble, wherein at the same time an assembly as intended is guaranteed. The contact pins preferably are finger like formed, e.g. cylindrical or hollow-cylindrical, such that they have a longitudinal axis. The contact pin inserts preferably are hollow sleeves, which provide a stop for the contact pins in the insert direction in the longitudinal axis, thereby defining the intended position of the contact pin in the contact pin insert.

The disclosure describes a mating interface, which optionally may be exchangeable, a contact pin insert, also referred to as a DC insert, two contact pins (i.e. a positive contact pin and a negative contact pin), also referred to as DC pins, and optionally a contact pin blocker, also referred to as a DC blocker. It should be noted that the invention is suited for non-cooled as well as for liquid-cooled or non-liquid-cooled connectors and/or charging cables. The connector in particular provides a plug-in-connection with a charging receptacle of an electric vehicle and comprises an opening for connection with a charging cable.

In one embodiment, the assembly includes the mating interface, the contact pin or several contact pins, the contact pin insert or several contact pin inserts and optionally a contact pin blocking element or several contact pin blocking elements is fixed to the connector housing/connector body. When combined with the connector housing/connector body, the inserts and optionally the blocking elements are locked and secured in position, in particular by an abutment onto the connector housing/connector body, and no motion of the said entities relative to the housing/body is possible. Specifically, forces along the direction of the central axis of the contact pins are passed over the contact pin insert into the mating interface and/or the connector housing/connector body, hindering any motion of the contact pins when the connector is mated with a car, or when it is extracted.

The systems and methods in accordance with the disclosure advantageously provide that the creepage distance can be designed very large, and for example can be as high as 137.5 mm, or more. A further advantage is, that the connector according to the invention does not require any screws or similar metal holding means, in particular in between the DC poles, nor close to the live parts to connect and mount the different parts of the connector.

While the contact pins consist of an electrically conductive material, as metal, in particular copper, the contact pin insert and/or the mating interface and/or the connector housing preferably consists/consist of an electrically insulating material, as plastic. Said parts preferably are plastic blow molded parts. By providing those parts of insulating material, the invention advantageously achieves a double insulating feature, thus enhancing the dielectric properties of the connector.

According to an implementation, the contact pin insert is secured in position within the mating interface by an abutment with the connector housing. This provides a very simple, effective solution for a secure positioning with a defined relation to the connector housing. Further, this implementation is very easy to assemble. In particular, the mating interface can comprise a mating structure, which positions the mating interface in a defined position within the connector housing/connector body. Further, the connector housing/connector body may comprise a mating structure against which the contact pin insert abuts, such that it is secured in position relative to the mating interface. The mating structure for the mating interface and the connector housing in particular may be a tongue and groove structure, whereas the mating structure of the contact pin insert and the connector housing may be a stop or shoulder or similar structure.

According to a further implementation, the contact pin insert is secured in position within the mating interface by a tongue and groove joint, which tongue and groove joint preferably is established directly in the contact pin insert and the mating interface. Preferably, the axis of the tongue and groove joint extends into the longitudinal direction of the contact pin insert and/or into the direction of assembly, when the contact pin insert is inserted into the mating interface, such that assembly is very easy.

According to a further implementation, the positive contact pin and/or the negative contact pin are secured in position within the contact pin insert by a press fit and/or gluing and/or a snap fit connection and/or a bayonet coupling. Preferably, the positive contact pin and/or the negative contact pin are secured in positon within the contact pin insert by a contact pin blocking element, which locks the contact pin in position. Specifically, the contact pin blocking element can bear forces along the direction of the central axis of the contact pins, hindering motion when the connector is mated with a car, or when it is extracted.

According to a further implementation, the positive contact pin and/or the negative contact pin are secured in positon within the contact pin insert by a bayonet coupling that provides a coupling-decoupling function by rotating the contact pin relative to the contact pin insert between a coupled position and a decoupled position, wherein the contact pin blocking element mates with the bayonet coupling in the coupled position such that a rotation in the decoupled position is locked.

The contact pin blocking element may comprise a reception for a thermocouple allowing abutment of the thermocouple with the contact pin.

Further, the contact pin insert, the positive contact pin and the negative contact pin each may comprise a mating structure ensuring that the positive contact pin and the negative contact pin cannot be confused and have to be assembled with the contact pin insert in the intended position.

According to a further implementation, the mating interface and the contact pin insert each comprise a mating structure ensuring that the contact pin insert has to be assembled with the mating insert in the intended position, such that the positive contact pin and the negative contact pin have to be arranged in the intended position.

According to a further implementation, the mating interface is reinforced by a reinforcing insert or a stiffening insert, in particular by a metal insert or steel insert. For example, the mating interface may include a space/receptacle/seat for incorporating the stiffening insert. The insert can be pressed and/or glued into the mating interface and serves to increase damage resistance of the connector and the mating interface during use and handling and in particular when used in a non-intended manner. The insert especially may help retaining structural integrity and protecting of the live parts of the connector from damage upon mechanical abuse of the interface.

The positive contact pin and/or the negative contact pin may be crimped and/or welded or soldered to a positive conductor of the charging cable and a negative conductor of a charging cable, respectively. Additionally or alternatively, the conductors of the charging cable may be connected to the concerning contact pins by a push-in mechanism, by screwing and/or by welding or soldering or brazing and/or by gluing.

According to a further implementation, the positive contact pins and/or the negative contact pin comprise/comprises a low-friction Ag-graphite composite coating.

According to a further implementation, the positive contact pin and/or the negative contact pin comprises/comprise pockets for thermocouples, pockets for contact springs close to tips of the concerning contact pin and/or stress relief openings at joints between different contact pins and/or cooling channels for receiving a coolant fluid from the charging cable. In particular, the blocking elements may comprise a pocket for receiving ceramic-coated thermocouples. Preferably, the blocking elements may comprise two pockets for such thermocouples, one for the positive contact pin and one for the negative contact pin. In this manner the thermocouples can be positioned in direct contact with the contact pins, in particular on their respective back side. Alternatively or additionally, a pocket for receiving the thermocouples may be included in the contact pins, and the thermocouple may be inserted from the side.

According to a preferred implementation, the connector additionally comprises a control pin (in particular two control pins), a control insert, and a control blocking element. Further, the connector optionally comprises a grounding pin and a control blocking element. The assembly of such control pin, control insert, control blocking element, grounding pin and control blocking element according to the invention is realized in the manner as described and disclosed with regard to the contact pin, the contact pin insert, the mating interface and optionally the contact pin blocking element. Therefore, any reference of this disclosure regarding a contact pin also refers to a control pin and/or a grounding pin. Further, any reference of this disclosure regarding a contact pin insert also refers to a control pin insert and/or a grounding pin insert. Further, any reference of this disclosure regarding a contact pin blocking element also refers to a control pin blocking element and/or a grounding pin blocking element.

In a further implementation, the blocking elements can be replaced by a “clicking” mechanism, which will have the same function—namely, keeping the contact pins in place. In such case, another blocking element may be anyhow provided for positioning and holding of thermocouples.

According to a further implementation, the blocking element may contain features for centering the contact pin insert and the blocking element. Similar features can be added to center the cables to the blocking element.

The shape of the blocking element may be adapted to and designed in a combinable manner with the shape of the contact pins. This may avoid any possible mistake when assembling the cables, which means that the positive contact pin (DC+) and the negative contact pin (DC−) cannot be confused. The same may apply according to a further implementation to the control pin insert. In particular, the contact pins may be symmetrically formed and/or have slightly different in dimensions. The result of such a design is that it is impossible to insert the contact pins in another way than intended and/or that a rotation of the concerning contact pin relative to the contact pin insert is impossible if the wrong pin is used or if a contact pin is used/assembled different than intended. A further embodiment of the invention is to have the contact pin insert with different dimensions, for example with two slightly different hole diameters, for each contact pin/DC+ and DC− poles.

The insulating casing particularly may be injection molded. It may be designed monolithically or it may consist of a plurality of distinct casing parts that are assembled to provide the connector housing. The insulating housing may be assembled with the other parts of the connector, in particular with its conducting parts as for example the first and/or the second connecting elements and/or the contacts. Alternatively, the insulating casing can be cast around or molded around the first connector element and/or the second connector element.

According to one implementation the contact pins are essentially finger-shaped. They may including stress relief features, or they can also be hollow cylinders including pockets for contact springs.

According to a further implementation, the contact pins comprise a low-friction plating. Such a plating for example may be an Ag-graphite composite. Due to a decreased friction during plug-in and plug-out procedures, the lifetime of the connector can be advantageously increased, such that in result an operating lifetime approaching or exceeding 100,000 mating cycles can be achieved. The contact pins in particular are processed by machining and/or 3D printing. Preferably they consist essentially of a copper alloy material, in particular of a CuCrZr-material or a CuBe-material.

The contacts may comprise pockets for thermocouples, pockets for contact springs close to tips of the contacts and/or stress relief openings at joints between different contacts and/or cooling channels connected to the fluid channels. The connecting elements may be directly or indirectly connected with the contact. Alternatively, the contacts and the connecting elements may be monolithically formed, in particular as a single block of copper.

To complete the assembly according to an implementation of the method of the invention, the contact pins are slide in the contact pin insert. Afterwards, when in the correct position, for example at the bottom of the insert, they are rotated, preferably around their longitudinal axis. At that point, it is no longer possible to slide the contact pin out of the contact pin insert due to the interlocking feature of the contact pin and the insert (i.e. a rotation is needed first). The blocking element may not only block movements along the axis of the contact pin, but also rotational movements around this axis. This feature is not always required, for example, when the contact pins may have different shapes and/or a rotationally asymmetric shape. In particular, depending on the cable concept implemented, the geometries of the pins may be adapted within the present invention.

The assembly of the connector may be done by sliding the contact pins into the contact pin inserts, and then sliding in the corresponding blocking elements. The latter may also have centering features for the cables. A double insulation may be achieved by using either sealing elements on both ends, or by potting the empty volume with an insulation material, for example silicone resin, silicone or soft epoxy, to guarantee insulation.

Further embodiments and advantages of the method are directly and unambiguously derived by the person skilled in the art from the system as described before.

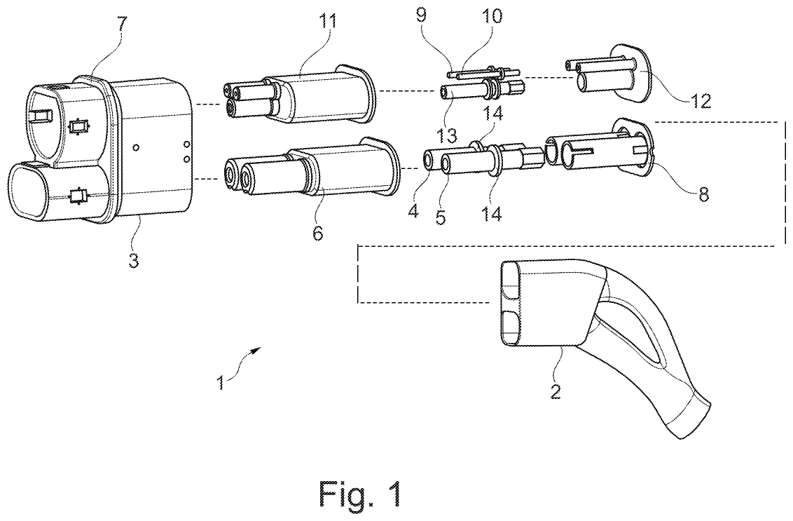

FIG. 1 shows an embodiment of an electrical plug connector 1 according to the invention in an explosion perspective view. The electrical plug connector 1 is suitable and intended for charging of electric vehicles (not shown). It comprises a connector housing 2, a mating interface structure 3 supported and positioned within the connector housing 2, a positive contact pin 4 for connection with a positive conductor (not shown) of a charging cable (not shown) and a negative con-tact pin 5 for connection with a negative conductor (not shown) of the charging cable.

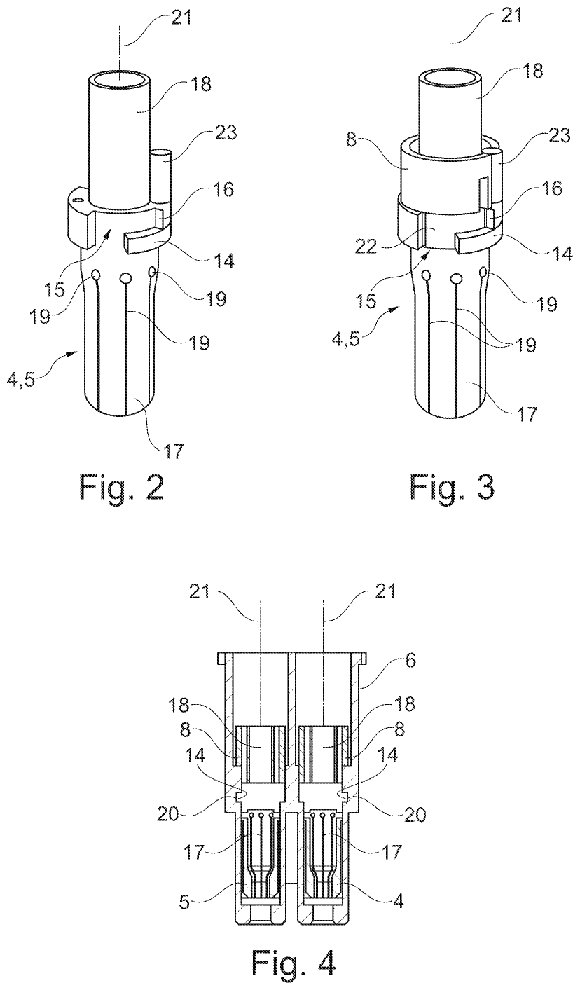

The connector further comprises a contact pin insert 6 for supporting the positive contact pin 4 and the negative contact pin 5. The positive contact pin 4 and the negative contact pin 5 are received and secured in position by the contact pin insert 6. Further, as it is shown in FIG. 2, the contact pin insert 6 is insertable and received within the mating interface structure 3. The contact pin insert 6 is se-cured in position within the mating interface structure 3 by an abutment in form of a tongue and groove joint with the connector housing. This joint comprises a tongue 7, which enters into a groove (not shown) of the connector housing 2.

The positive contact pin 4 and the negative contact pin 5 are secured in positon within the contact pin insert 6 by a contact pin blocking element 8, which locks the contact pins 4, 5 in position.

The connector 1 additionally comprises a two control pins 9, 10, a control insert 11, and a control blocking element 12. Further, the connector 1 comprises a grounding pin 13. The control blocking element 12 secures the assembly of the control pins 9, 10, the control insert 11 and the grounding pin 13 in the manner as described and disclosed with regard to the contact pins 4, 5, the contact pin insert 6, the mating interface 3 and the contact pin blocking element 8. The positive con-tact pin 4 and the negative contact pin 5 each comprises a low-friction Ag-graphite composite coating (not shown).

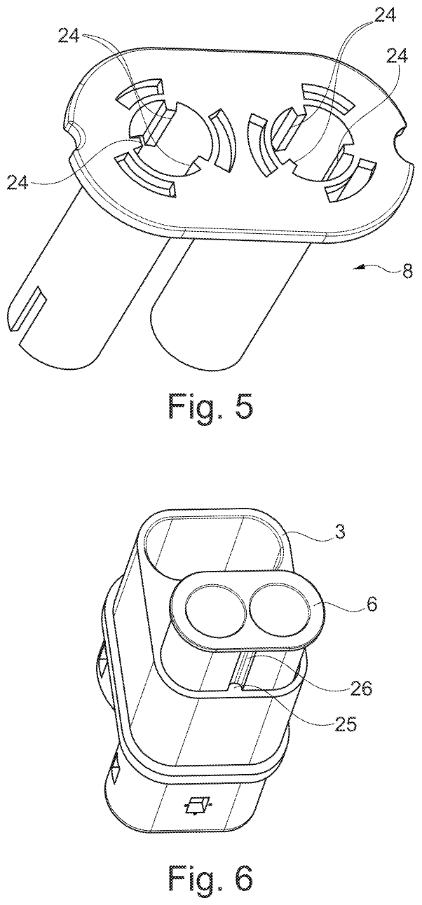

As especially is shown in FIGS. 4 and 5, the positive contact pin 4 and the negative contact pin 5 are secured in positon within the contact pin insert 6 by a bayonet coupling that provides a coupling-decoupling function by rotating the concerning contact pin 4, 5 relative to the contact pin insert 6 between a coupled position and an uncoupled position. The bayonet coupling here consists of a circumferentially arranged shoulder 14 extending radially from the contact pin 4, 5. This shoulder 14 has a through hole 15 and a stop 16. Further, as it is shown in FIGS. 4 and 5, the contact pins 4, 5 each comprise a plug connecting portion 17 and a cable connecting portion 18. The plug connecting portion 17 comprises stress relief features 19. The shoulder 14 of the contact pins 4, 5 cooperate with correspondingly formed stopper structure or groove 20 of the contact pin insert 6 (see FIG. 6). When sliding the contact pin 4, 5 into the contact pin insert 6, this groove 20 passes the through hole 15 of the shoulder 14. When in the intended axial position, the shoulder 14 is in the same axial position as the groove 20. By turning the contact pin 4, 5 around his longitudinal axis 21, the shoulder 14 enters into the groove 20, as shown in FIG. 6. In this position the contact pin blocking element 8 is axially inserted into the contact pin insert 6, wherein a protrusion 22 of the contact pin blocking element 8 enters into and passes the through hole 15. The contact pin blocking element 8 mates with the shoulder 14 of the bayonet coupling in the coupled position (see FIG. 5) such that a rotation of the contact pin 4, 5 in the con-tact pin insert 6 out of the coupled position into the decoupled position is locked. Further, the contact pin blocking element 8 comprises a reception for a thermo-couple 23 allowing abutment of the thermocouple 23 with the contact pin 4, 5.

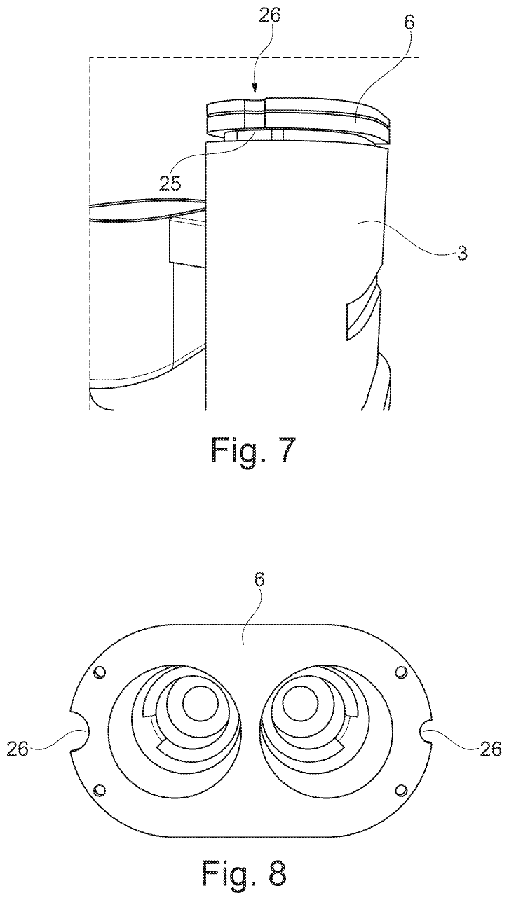

As especially shown in FIGS. 7, 8 and 9, the contact pin insert 6, the positive con-tact pin 4 and the negative contact pin 5 each comprise a mating structure 24 in form of rips 24 (the mating structures of the contact pins 4, 5 are not shown) ensuring that the positive contact pin 4 and the negative contact pin 5 cannot be confused and have to be assembled with the contact pin insert 6 in the intended position, as the mating structure 24 for/of the positive contact pin 4 differs from that for/of the negative contact pin 5. Additionally, the mating interface 3 and the contact pin insert 6 each comprise a mating structure 25 and 26, respectively. These mating structures 25, 26 ensure that the contact pin insert 6 has to be assembled with the mating insert 3 in the intended position, such that the positive contact pin 4 and the negative contact pin 5 have to be arranged in the intended position. In the example of FIG. 8 the mating structure 25 of the mating interface 3 is a protrusion 25 extending on an inner wall, while the mating structure 26 is a correspondingly formed groove 26 on the outside of the contact pin insert 6. In the example of FIG. 9 the mating structure 25 of the mating interface 3 is a protrusion 24 arranged on the top of the mating interface, while the mating structure 26 is a correspondingly formed groove 26 on the outside of the contact pin insert 6 (see also FIG. 10). FIG. 10 shows that the contact pin insert 6 comprises one groove 26 on each side, wherein the grooves 26 are of different size, to prohibit an assembly in an unintended manner.

As shown in FIG. 3, the mating interface 3 is reinforced by a reinforcing insert 27, in particular by a metal insert 27 or steel insert 27.

### REFERENCE SIGNS LIST

1 electrical plug connector, charging connector
2 connector housing, connector body
3 mating interface structure, mating interface
4 positive contact pin
5 negative contact pin
6 contact pin insert
7 abutment, tongue
8 contact pin blocking element
9 control pin
10 control pin
11 control insert
12 control blocking element
13 grounding pin
14 shoulder
15 through hole
16 stop
17 plug connecting portion
18 cable connecting portion
19 stress relief features
20 stopper structure, groove
21 longitudinal axis
22 protrusion
23 thermocouple
24 mating structure, rips
25 mating structure, protrusion
26 mating structure, groove
27 reinforcing insert

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electrical plug connector for charging electric vehicles, comprising:
a connector housing,
a mating interface structure supported and positioned within the connector housing,
a positive contact pin configured for connection with a positive conductor of a charging cable and a negative contact pin configured for connection with a negative conductor of the charging cable, and
a contact pin insert configured for supporting at least one of the positive contact pin and the negative contact pin,
wherein the positive contact pin and/or the negative contact pin are/is received and secured in position by the contact pin insert, and
wherein the contact pin insert is insertable and received within the mating interface structure.

2. The electrical plug connector of claim 1, wherein the contact pin insert is secured in position within the mating interface by an abutment with the connector housing.

3. The electrical plug connector of claim 1, wherein the contact pin insert is secured in position within the mating interface by a tongue and groove joint, which tongue and groove joint is disposed between the contact pin insert and the mating interface.

4. The electrical plug connector of claim 1, wherein the positive contact pin and/or the negative contact pin are secured in positon within the contact pin insert by one of a press fit, gluing, a snap fit connection, and a bayonet coupling.

5. The electrical plug connector of claim 1, wherein the positive contact pin and/or the negative contact pin are secured in position within the contact pin insert by a contact pin blocking element, which locks the contact pin in position.

6. The electrical plug connector of claim 1, wherein the positive contact pin and/or the negative contact pin are secured in positon within the contact pin insert by a bayonet coupling that provides a coupling-decoupling function by rotating the contact pin relative to the contact pin insert between a coupled position and a decoupled position, wherein the contact pin blocking element mates with the bayonet coupling in a coupled position such that a rotation in a decoupled position is locked.

7. The electrical plug connector of claim 5, wherein the contact pin blocking element comprises a reception for a thermocouple allowing abutment of the thermocouple with the contact pin.

8. The electrical plug connector of claim 1, wherein the contact pin insert, the positive contact pin and the negative contact pin each comprises a mating structure ensuring that the positive contact pin and the negative contact pin cannot be confused and have to be assembled with the contact pin insert in an intended position.

9. The electrical plug connector of claim 1, wherein the mating interface and the contact pin insert each comprises a mating structure ensuring that the contact pin insert has to be assembled with the mating insert in an intended position, such that the positive contact pin and the negative contact pin are arranged in their respective intended position.

10. The electrical plug connector of claim 1, wherein the mating interface is reinforced by a reinforcing insert, in particular by a metal insert or steel insert.

11. The electrical plug connector of claim 1, wherein the positive contact pin and/or the negative contact pin is/are at least one of crimped, welded, and soldered, to a positive conductor of the charging cable and a negative conductor of a charging cable, respectively.

12. The electrical plug connector of claim 1, wherein the positive contact pin and/or the negative contact pin comprise(s) a low-friction Ag-graphite composite coating.

13. The electrical plug connector of claim 1, wherein the positive contact pin and/or the negative contact pin comprise(s) at least one of: pockets for thermocouples, pockets for contact springs close to tips of the concerning contact pin, stress relief openings at joints between different contact pins, and cooling channels for receiving a coolant fluid from the charging cable.

14. A method for assembling an electrical plug connector for use with an electrical plug connector, comprising:
inserting a contact pin for connection with a conductor of a charging cable into a contact pin insert for supporting the contact pin,
securing the contact pin in position by the contact pin insert,
inserting the contact pin insert with the contact pin supported and secured in position therein into the mating interface structure, and
inserting the mating interface structure with the contact pin insert and the contact pin into a connector housing, such that the mating interface structure is supported and positioned within the connector housing.

15. The method of claim 14, wherein the contact pin insert is secured in position within the mating interface by an abutment with the connector housing.
